(19) United States
(12) Patent Application Publication
(10) Pub. No.: US 2020/0008226 A1
(43) Pub. Date: Jan. 2, 2020

(54) BASE STATION AND USER APPARATUS

(71) Applicant: NTT DOCOMO, INC., Tokyo (JP)

(72) Inventors: Yousuke Sano, Tokyo (JP); Kazuki Takeda, Tokyo (JP); Kazuaki Takeda, Tokyo (JP); Satoshi Nagata, Tokyo (JP)

(73) Assignee: NTT DOCOMO, INC., Tokyo (JP)

(21) Appl. No.: 16/483,593

(22) PCT Filed: Jan. 22, 2018
(86) PCT No.: PCT/JP2018/001830

§ 371 Date: Aug. 5, 2019

(30) Foreign Application Priority Data
Feb. 10, 2017 (JP) 2017-023566

(51) Int. Cl. H04W 72/12; H04W 72/04

(52) U.S. Cl. CPC H04W 72/1278; H04W 24/10; H04W 72/046

(57) ABSTRACT

Techniques for transmission and reception of a control channel with a directional beam are disclosed. One aspect of the present invention relates to a base station, comprising: a scheduling unit configured to allocate a radio resource to a user apparatus; and a signal processing unit configured to process a radio signal for transmission to and reception from the user apparatus, wherein the scheduling unit allocates control information for transmission to the user apparatus to a radio resource within a search space specific to the user apparatus, and the signal processing unit transmits the control information to the user apparatus with a transmission beam corresponding to the allocated radio resource among multiple types of transmission beams.

### TECHNICAL FIELD

The present invention relates to a radio communication system.

### BACKGROUND ART

Presently, specifications for a fifth generation (5G) or NR (New RAT) system are being designed as a next radio communication system of LTE (Long Term Evolution) and LTE-Advanced. In the NR system, there is discussion of two-step beam management as illustrated in FIG. 1 being utilized for transmission and reception of radio signals with directional beams between a user apparatus and a base station.

Specifically, as illustrated in FIG. 1, at the first step, a TRP (Transmission and Reception Point) or a base station (gNB or BS) transmits MRSs (Mobility Reference Signals) specific to cells associated with measurement beams (B1 to B3 in the illustrated example). At the first step, the base station transmits transmission beams (or beam groups) having beam widths greater than those at the second step. The user apparatus (UE) measures the respective transmission beams from the base station. The user apparatus identifies the best received transmission beams (B2 in the illustrated example) and reports measurement results (an RSRP (Reference Signal Received Power), an RSRQ (Reference Signal Received Quality) or the like) together with a beam ID of the identified transmission beam to the base station. Instead of the beam ID, the user apparatus may report radio resources for the best received MRS. In this manner, rough beam measurement using the MRSs having greater beam widths performed at the first step.

Next, at the second step, the TRP transmits finer transmission beams, that is, CSI-RSs (Channel State Information-Reference Signals) associated with transmission beams having smaller beam widths (B21 to B24 in the illustrated example). The user apparatus uses the CSI-RSs to measure the finer transmission beams. The user apparatus may also apply multiple reception beams to detect BPLs (Beam Pair Links) indicative of pairs of the transmission beams and the reception beams. Note that the BPL is referred to as “spatial QCL assumption between an DL RS antenna port(s), and DL RS antenna port(s) for demodulation of DL control channel” in 3GPP (Third Generation Partnership Project).

The user apparatus reports CSI (Channel State Information) and CRIs (CSI-RS Resource Indices) (for example, CSI-RS #1 to #4) for one or more better received CSI-RSs to the base station. The base station indicates a BPL for a PDCCH (Physical Downlink Control Channel) and a PDSCH (Physical Downlink Shared Channel) for subsequent transmission, that is, QCL (Quasi-Co-Location) between a CSI-RS and a DM-RS (Demodulation-Reference Signal), to the user apparatus. Here, the BPL for the PDCCH may be indicated in RRC (Radio Resource Control) or MAC (Medium Access Control), and the BPL for the PDSCH may be indicated in DCI (Downlink Control Information).

### PRIOR ART DOCUMENT

### Non-Patent Document

[Non-Patent Document 1] 3GPP TS 36.213 V14.1.0 (2016-12)

### SUMMARY OF INVENTION

### Problem to be Solved by the Invention

In the NR, it is agreed that reference signals for beam management (CSI-RSs or the like) are composed of K transmission beams, for example, and the user apparatus measures the K transmission beams and transmits measurement results of selected N transmission beams (K>N) to the base station. Note that the N does not need to be set to a fixed value, and the selection of N beams and/or the identification manner are not limited to any specific manner. Also, it is agreed that the user apparatus reports at least the measurement results (for example, a CSI, an RSRP or both) and information for identifying the N transmission beams.

The measurement results may be an RSRP, an RSRQ, CSI and so on. Also, the different measurement results may be used corresponding to purposes. For example, the RSRP/RSRQ may be used for mobility, and the CSI may be used for link adaptation. The reported contents may be indicated with bit representation in the RRC and/or the DCI (for example, “01: RSRP”, “10: CSI”, “11: Both” or the like).

Also, for example, a CSI-RS resource ID, an antenna port index, a combination of an antenna port index and a time index, a sequence index or the like may be considered as the information for identifying transmission beams. For example, if K=4 and N=3, as illustrated in FIG. 2, the base station may transmit CSI-RS#1 to CSI-RS#4 with four finer transmission beams B21 to B24, respectively, for the transmission beam B2 that has been reported as the best one at the first step, and the user apparatus may identify the best three reception beams with respect to reception quality and report CSI-RS resources associated with the identified beams to the base station.

Here, association of the CSI-RS with the DM-RS is needed for the PDCCH. If there is a single type of DM-RS, flexibility will be insufficient. Accordingly, multiple types of DM-RSs having different properties (a transmission sequence, a transmission resource or the like) are defined as DM-RS ports (for example, ports 5, 7 to 14 in the LTE). Also, some information is associated with the DM-RS port. For example, a DM-RS port is associated with a MIMO (Multiple-Input Multiple-Output) layer in the LTE (for example, layer 1→port 7, layer 2→port 8 and so on). Similarly, a transmission beam may be associated with a DM-RS port, and multiple transmission beams may be associated with a single DM-RS port. Basically, an NR PDCCH may be transmitted with a single type of DM-RS port, and determination as to which DM-RS port is to be used may be made by the base station. When the base station transmits the NR PDCCH, the base station applies the transmission beam associated with the DM-RS port over the entire PDCCH including DCI. Accordingly, only the transmission beam associated with the DM-RS port needs to be considered for the transmission beam for the NR PDCCH. Here, association of the DM-RS port with the transmission beam may be determined based on a MRS and/or a CSI-RS.

In the example as illustrated in FIG. 2, when the user apparatus determines that the best BPL is the pair of transmission beam B23 and reception beam b3 measured with CSI-RS#3, the user apparatus reports the pair of B23 and b3 as the best BPL to the base station and associates the BPL with DM-RS port 0. Also, when the user apparatus determines that the second best BPL is the pair of transmission beam B22 and reception beam b2 measured with CSI-RS#2, the user apparatus reports the pair of B22 and b2 as the second best BPL to the base station and associates the BPL with DM-RS port 1. Furthermore, when the user apparatus determines that the third best BPL is the pair of transmission beam B21 and reception beam b3 measured with CSI-RS #1, the user apparatus reports the pair of B21 and b3 as the third best BPL to the base station and associates the BPL with DM-RS port 0.

Here, a downlink control channel domain includes a common search space (C-SS) and a UE specific search space (UE-SS), and each user apparatus receives the common search space and the UE specific search space for the user apparatus in a blind manner. For a control channel associated with the UE specific search space, association of CSI-RS ports for an NR-PDCCH (that is, transmission beams) with DM-RSs is indicated from the base station to the user apparatus. For example, the base station may indicate that DM-RS#0 is associated with CSI-RSs#1 and #3 and DM-RS#1 is associated with CSI-RS#2. The association is determined from a CRI (and a reception beam ID) reported from the user apparatus and is indicated by RRC or MAC signaling.

For a control channel associated with the common search space, on the other hand, association of MRS ports for the NR-PDCCH with DM-RS ports is indicated from the base station to the user apparatus. The association is determined based on information regarding transmission beams and is indicated by RRC or MAC signaling or in system information grouped for user apparatuses(for example, a SIB (System Information Block)).

In this manner, the case where the user apparatus reports the multiple BPLs (for example, the best BPL, the second best BPL and the third best BPL), the base station can select the BPL for the NR PDCCH from the reported BPLs . It is assumed that the BPL is reported by RRC semi-statically, typically in unit of tens of milliseconds, and there may be changes in the best BPL. Accordingly, the base station needs to select the second or third best BPL for transmission of the NR PDCCH so as to follow the channel variation in a time domain. Also, in the case where the respective BPLs are associated with different CCEs and radio resources (for example, a CCE (Control Channel Element)) associated with the best BPL are insufficient, the base station may need to select the second or third best BPL for transmission of the NR PDCCH. Also, the user apparatus needs to know which BPL is used for the NR PDCCH to determine the direction of a reception beam (for example, b2 or b3).

In light of the above problems, an object of the present invention is to provide techniques for transmission and reception of a control channel with a directional beam.

### Means for Solving the Problem

In order to overcome the above problem, one aspect of the present invention relates to abase station, comprising: a scheduling unit configured to allocate a radio resource to a user apparatus; and a signal processing unit configured to process a radio signal for transmission to and reception from the user apparatus, wherein the scheduling unit allocates control information for transmission to the user apparatus in a radio resource within a search space specific to the user apparatus, and the signal processing unit transmits the control information to the user apparatus with a transmission beam corresponding to the allocated radio resource among multiple types of transmission beams.

### Advantage of the Invention

According to the present invention, control channels can be transmitted and received with a directional beam.

### BRIEF DESCRIPTION OF DRAWINGS

FIG. 1 is a schematic diagram for illustrating exemplary beam management;

FIG. 2 is a schematic diagram for illustrating exemplary CSI-RS configuration and beam reporting;

FIG. 3 is a schematic diagram for illustrating exemplary beam reporting;

FIG. 4 is a schematic diagram for illustrating a radio communication system according to one embodiment of the present invention;

FIG. 5 is a block diagram for illustrating a functional arrangement of a base station according to one embodiment of the present invention;

FIG. 6 is a schematic diagram for illustrating arrangement of CCEs for transmitting a PDCCH according to one embodiment of the present invention;

FIG. 7 is a block diagram for illustrating a functional arrangement of a user apparatus according to one embodiment of the present invention;

FIG. 8 is a schematic diagram for illustrating arrangement of CCEs for transmitting a PDCCH according to one embodiment of the present invention;

FIG. 9 is a schematic diagram for illustrating arrangement of CCEs for transmitting a PDCCH according to one embodiment of the present invention;

FIG. 10 is a schematic diagram for illustrating arrangement of CCEs for transmitting a PDCCH according to one embodiment of the present invention;

FIG. 11 is a schematic diagram for illustrating arrangement of CCEs for transmitting a PDCCH according to one embodiment of the present invention; and

FIG. 12 is a block diagram for illustrating a hardware arrangement of a base station and a user apparatus according to one embodiment of the present invention.

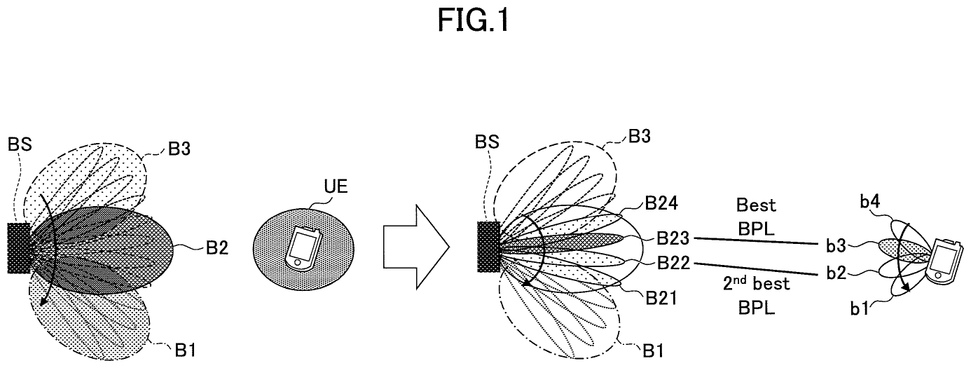

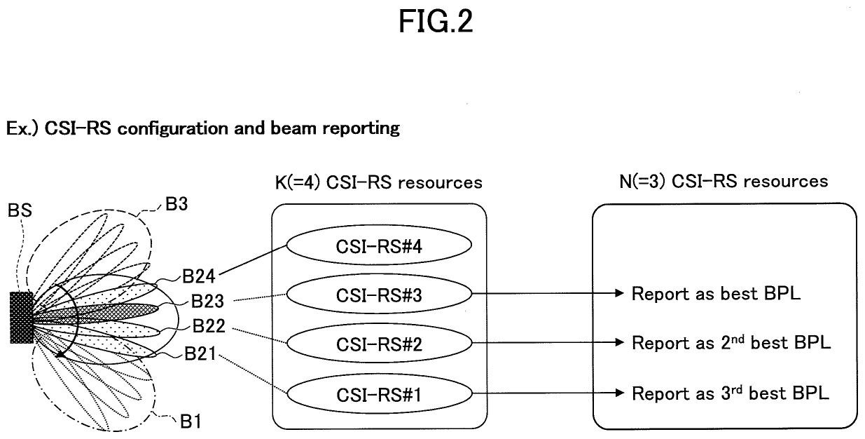

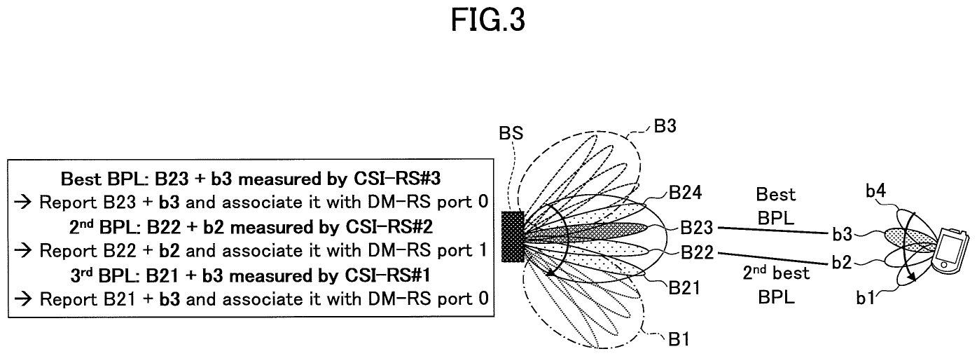

### EMBODIMENTS OF THE INVENTION

Embodiments of the present invention are described below with reference to the drawings.

In the following embodiments, a base station and a user apparatus for transmitting and receiving a control channel with a directional beam are disclosed. According to embodiments as described below, when multiple pairs (for example, BPLs) of transmission beams and reception beams resulting in a good reception quality and selected by the user apparatus based on beam measurement are reported, the base station transmits radio signals including control information to the user apparatus in a radio resource segmented within a search space (for example, a UE-SS) specific to the user apparatus with a transmission beam associated with the radio resource. Upon receiving the radio signal in the radio resource within the search space specific to the user apparatus, the user apparatus decodes the radio signal received with a reception beam corresponding to the received radio resource. As a result, the control information transmitted with the transmission beam resulting in the good reception quality can be decoded with the corresponding reception beam, and the control signal can be obtained more reliably.

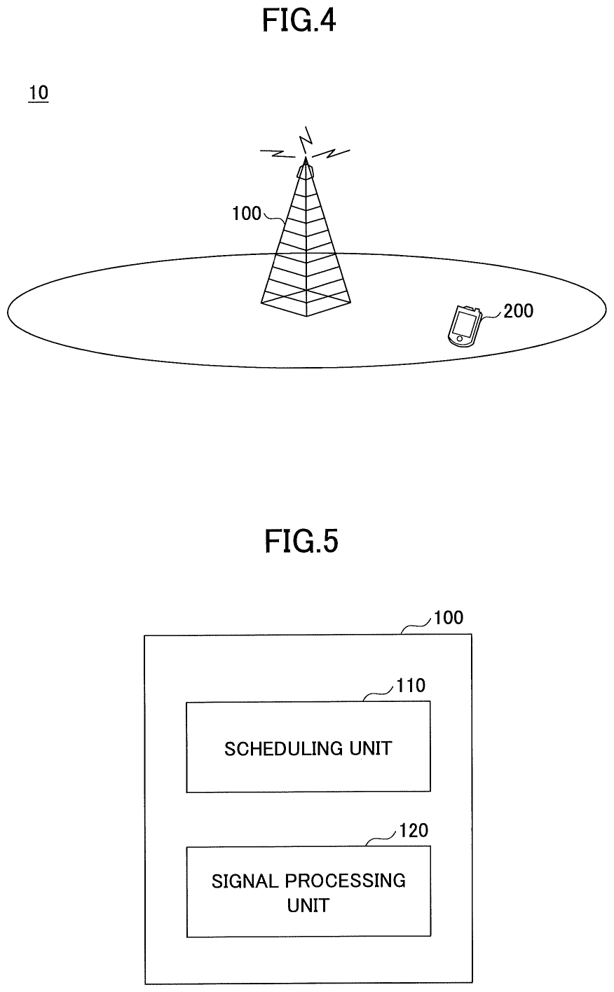

At the outset, a radio communication system according to one embodiment of the present invention is described with reference to FIG. 4. FIG. 4 is a schematic diagram for illustrating a radio communication system according to one embodiment of the present invention.

As illustrated in FIG. 4, a radio communication system 10 has a base station 100 and a user apparatus 200. In the following embodiments, the radio communication system 10 is a radio communication system compliant with standards subsequent from 3GPP Rel-14 (for example, a 5G or NR system). However, the present invention is not limited to it, and it may be any other radio communication system where a control channel is transmitted and received with a directional beam.

The base station 100 serves one or more cells for radio communication with the user apparatus 200. In the illustrated embodiment, only the single base station 100 is illustrated, but a large number of base stations 100 are generally disposed to cover a service area of the radio communication system 10.

The user apparatus 200 is any appropriate information processing device with radio communication functionalities such as a smartphone, a mobile phone, a tablet, a wearable terminal and a communication module for M2M (Machine-to-Machine), and the user apparatus 200 wirelessly connects to the base station 100 to use various communication services served from the radio communication system 10.

In the present embodiment, multiple pairs (BPLs) of transmission beams and reception beams are selected based on measurement results on reference signals (for example, MRSs) with beams having a greater beam width and reference signals (for example, CSI-RSs) with beams having a smaller beam width, and a PDCCH is transmitted in a user specific search space with the selected pairs.

Next, a base station according to one embodiment of the present invention is described with reference to FIG. 5. FIG. 5 is a block diagram for illustrating a functional arrangement of the base station according to one embodiment of the present invention.

As illustrated in FIG. 5, the base station 100 has a scheduling unit 110 and a signal processing unit 120.

The scheduling unit 110 allocates a radio resource to the user apparatus 200. Specifically, the scheduling unit 110 allocates various radio signals such as a downlink/uplink control signal and a downlink/plink data signal to radio resources and performs downlink and uplink communication with the user apparatus 200 in the allocated radio resources.

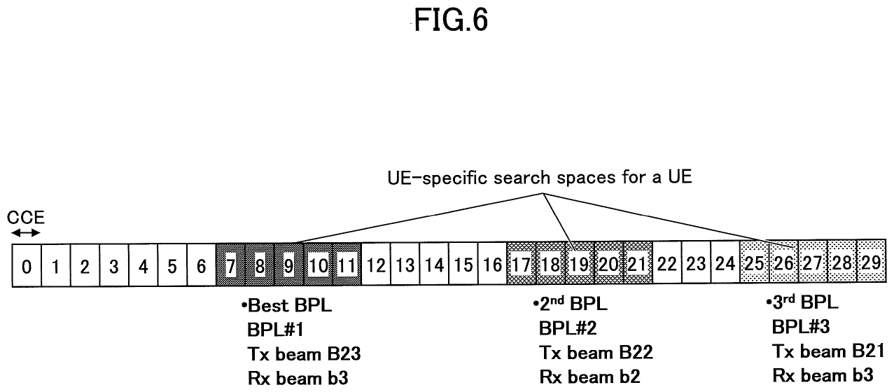

In this embodiment, scheduling unit 110 allocates control information for transmission to the user apparatus 200 in a radio resource within a search space specific to the user apparatus 200. Specifically, as illustrated in FIG. 6, the scheduling unit 110 segments the UE-SS, where the radio resources are allocated on a per-CCE basis, into multiple subsets (CCEs#7-#11, CCEs#17-#21 and CCEs#25-#29) and associates these subsets with BPLs#1-#3, respectively. In the illustrated example, the scheduling unit 110 segments the UE-SS into the three subsets and associates the best BPL#1, the second best BPL#2 and the third best BPL#3, which are selected by the user apparatus 200 based on beam measurements, with the segmented three subsets. Here, the respective BPLs are composed of pairs of transmission beams and reception beams. The scheduling unit 110 allocates a PDCCH or DCI for the user apparatus 200 to one or more radio resources within these three subsets.

The signal processing unit 120 processes a radio signal for transmission to and reception to from the user apparatus 200. Specifically, for downlink communication, the signal processing unit 120 performs beam control operations (for example, multiplication of precoding vectors) on a radio signal for transmission to the user apparatus 200 and transmits the radio signal with a directional beam. Also, for uplink communication, the signal processing unit 120 performs the corresponding beam control operations on a radio signal received from the user apparatus 200 with a directional beam and retrieves various types of information, such as control information (for example, a PUCCH (Physical Uplink Control Channel)) and/or data information (for example, a PUSCH (Physical Uplink Shared Channel)), from the decoded radio signal. Also, the signal processing unit 120 determines a pair (BPL) of a transmission beam and a reception beam for use with the user apparatus 200 in accordance with one or more BPLs reported from the user apparatus 200 based on beam measurements on MRSs and/or CSI-RSs or the like.

In this embodiment, the signal processing unit 120 transmits the control information to the user apparatus 200 with a transmission beam corresponding to the allocated radio resource among multiple types of transmission beams. Specifically, as illustrated in FIG. 6, the signal processing unit 120 transmits a radio signal including a PDCCH to the user apparatus 200 in a radio resource in subsets (CCEs#7-#11, CCEs#17-#21 and CCEs#25-#29) segmented from a UE-SS with a transmission beam associated with the radio resource. In the illustrated example, the signal processing unit 120 transmits CCEs#7-#11, CCEs#17-#21 and CCEs#25-#29 with transmission beams B23, B22 and B21, respectively.

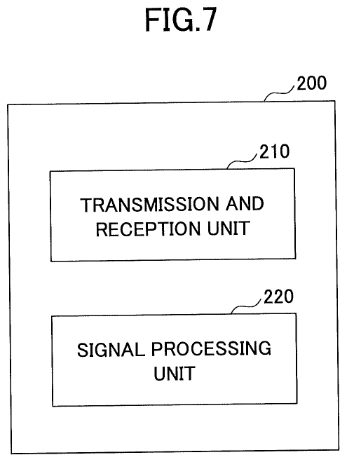

Next, the user apparatus according to one embodiment of the present invention is described with reference to FIG. 7. FIG. 7 is a block diagram for illustrating a functional arrangement of the user apparatus according to one embodiment of the present invention.

As illustrated in FIG. 7, the user apparatus 200 has a transmission and reception unit 210 and a signal processing unit 220.

The transmission and reception unit 210 transmits and receives a radio signal to and from the base station 100. Specifically, the transmission and reception unit 210 transmits and receives various radio signals, such as a downlink/uplink control signal and a downlink/uplink data signal, to and from the base station 100. For example, the transmission and reception unit 210 performs beam control operations on a to-be-transmitted radio signal to transmit the radio signal with a directional beam. On the other hand, the transmission and reception unit 210 retrieves various types of information, such as control information (for example, a PDCCH) and/or data information (for example, a PDSCH), from the received radio signal. Also, the transmission and reception unit 210 measures a reference signal received from the base station 100, such as a MRS and/or a CSI-RS or the like, and reports one or more BPLs indicative of pairs of transmission beams and reception beams to the base station 100 based on measurement results.

In this embodiment, the transmission and reception unit 210 receives a radio signal in a radio resource in a search space specific to the user apparatus 200. Specifically, as illustrated in FIG. 6, the transmission and reception unit 210 receives radio signals transmitted with transmission beams (B23, B22 and B21) in radio resources in subsets (CCEs#7-#11, CCEs#17-#21 and CCEs#25-#29) segmented within the UE-SS for the user apparatus 200.

The signal processing unit 220 processes a radio signal. Specifically, the signal processing unit 220 performs various radio signal processing such as encoding/decoding and modulation/demodulation on a radio signal for transmission to and reception from the base station 100.

In this embodiment, the signal processing unit 220 decodes the radio signal with a reception beam corresponding to the received radio resource among multiple types of reception beams and retrieves control information transmitted to the user apparatus 200. Specifically, as illustrated in FIG. 6, the signal processing unit 220 blindly decodes radio signals transmitted in CCEs#7-#11, CCEs#17-#21 and CCEs#25-#29 with reception beams b3, b2 and b3, respectively, and retrieves a PDCCH or DCI from the received radio signal.

In one embodiment, the scheduling unit 110 may configure the number of radio resources allowed to transmit the control information for each transmission beam in the multiple types of transmission beams. In this case, the transmission and reception unit 210 may receive a radio signal in a number of radio resources configured for each reception beam in the multiple types of reception beams, and the signal processing unit 220 may decode the radio signal with a reception beam corresponding to the configured number of radio resources and retrieve the control information transmitted to the user apparatus 200. For example, the number of radio resources allowed to transmit a PDCCH and allocated for respective BPLs (PDCCH candidates) may be set to different values.

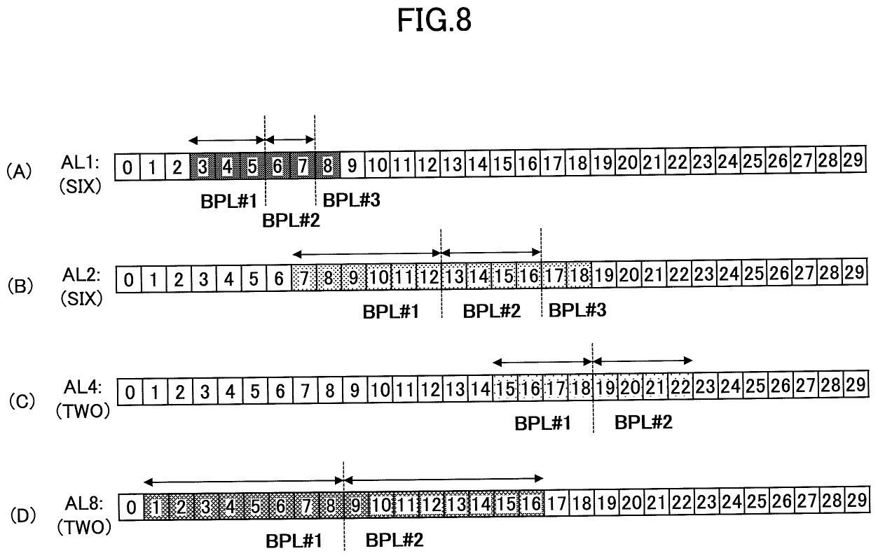

Specifically, as illustrated in FIG. 8, the number of radio resources allowed to transmit the PDCCH and associated with the respective BPLs may be configured on a per-BPL basis. For example, the number of radio resources allowed to transmit a PDCCH and associated with each BPL (PDCCH candidates) may be configured on a per-BPL basis. For example, as illustrated in FIG. 8A where an aggregation level is 1 (AL=1), the scheduling unit 110 may allocate three CCEs, two CCEs and one CCE for the best BPL (BPL#1), the second best BPL (BPL#2) and the third best BPL (BPL#3), respectively. Also, as illustrated in FIG. 8B for AL=2, the scheduling unit 110 may allocate six CCEs, four CCEs and two CCEs for BPL#1, BPL#2 and BPL#3, respectively. Also, as illustrated in FIG. 8C for AL=4, the scheduling unit 110 may allocate four CCEs for each of BPL#1 and BPL#2. Also, as illustrated in FIG. 8D for AL=8, the scheduling unit 110 may allocate eight CCEs for each of BPL#1 and BPL#2. Typically, a larger number of PDCCH candidates may be allocated to a BPL assumed to have good properties. If a radio signal is transmitted to the user apparatus 200 in such a radio resource configuration, the transmission and reception unit 210 receives the radio signal in CCEs within the UE-SS for the user apparatus 200, and the signal processing unit 220 applies a reception beam corresponding to the received radio signal to retrieve various types of information including the PDCCH from the radio signal.

According to this embodiment, a larger number of PDCCH candidates are allocated to a BPL having good properties, and the PDCCH can be accordingly received more reliably.

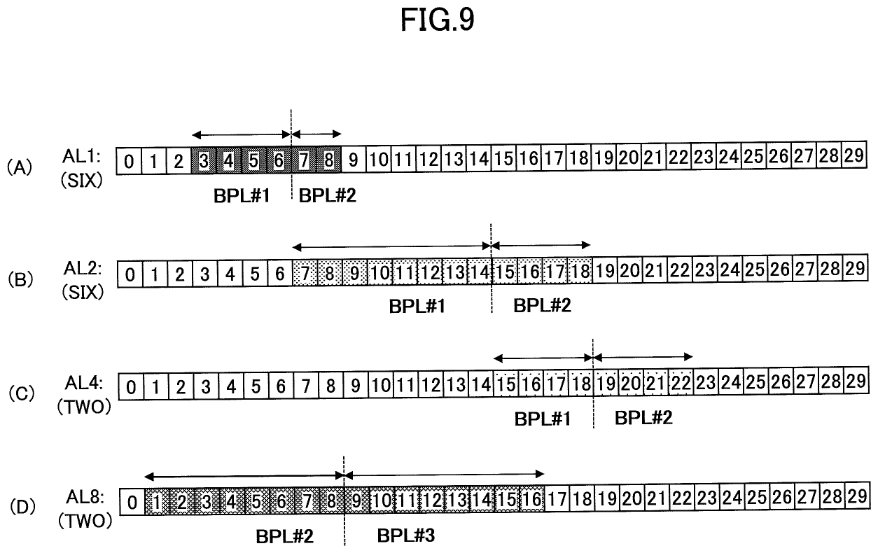

Also, in one embodiment, the scheduling unit 110 may select a transmission beam to be used from the multiple types of transmission beams corresponding to an aggregation level (AL). In this case, the transmission and reception unit 210 may receive the radio signal in a radio resource configured for each reception beam selected from the multiple types of reception beams corresponding to an aggregation level, and the signal processing unit 220 may decode the radio signal with a reception beam corresponding to the received radio resource and retrieve the control information transmitted to the user apparatus 200. For example, as the aggregation level is higher, that is, as the reception quality degrades, a BPL having a lower quality may be preferentially allocated (FIG. 9D). Also, in the case where the aggregation level is low, that is, the reception quality is good, a BPL having a low quality (for example, BPL#3) may be unused.

Specifically, in the example as illustrated in FIG. 9A for AL=1, four CCEs and two CCEs are allocated to BPL#1 and BPL#2, respectively. For AL=2, as illustrated in FIG. 9B, eight CCEs and four CCEs are allocated to BPL#1 and BPL#2, respectively. Also, for AL=4, as illustrated in FIG. 9C, four CCEs are allocated to each of BPL#1 and BPL#2. Also, for AL=8, as illustrated in FIG. 9D, eight CCEs are allocated to each of BPL#2 and BPL#3. In this case, the transmission and reception unit 210 receives a radio signal in a CCE within the UE-SS for the user apparatus 200, and the signal processing unit 220 applies a reception beam to the received radio signal to retrieve various types of information including a PDCCH from the radio signal. When the radio signal is transmitted to the user apparatus 200 in such a radio resource configuration, the transmission and reception unit 210 receives the radio signal in a CCE within the UE-SS for the user apparatus 200, and the signal processing unit 220 applies a reception beam corresponding to the received radio signal to retrieve various types of information including the PDCCH from the radio signal.

According to this embodiment, an appropriate BPL corresponding to the aggregation level or the reception quality is used, and the PDCCH can be accordingly received more reliably.

Also, in one embodiment, the scheduling unit 110 may cause radio resources allowed to transmit the control information with each transmission beam in the multiple types of transmission beams to be overlapped with respect to different aggregation levels. In this case, the transmission and reception unit 210 may receive the radio signal in a radio resource configured for each reception beam in the multiple types of reception beams corresponding to an aggregation level, and the signal processing unit 220 may decode the radio signal with a reception beam corresponding to the received radio resource and retrieve the control information transmitted to the user apparatus 200.

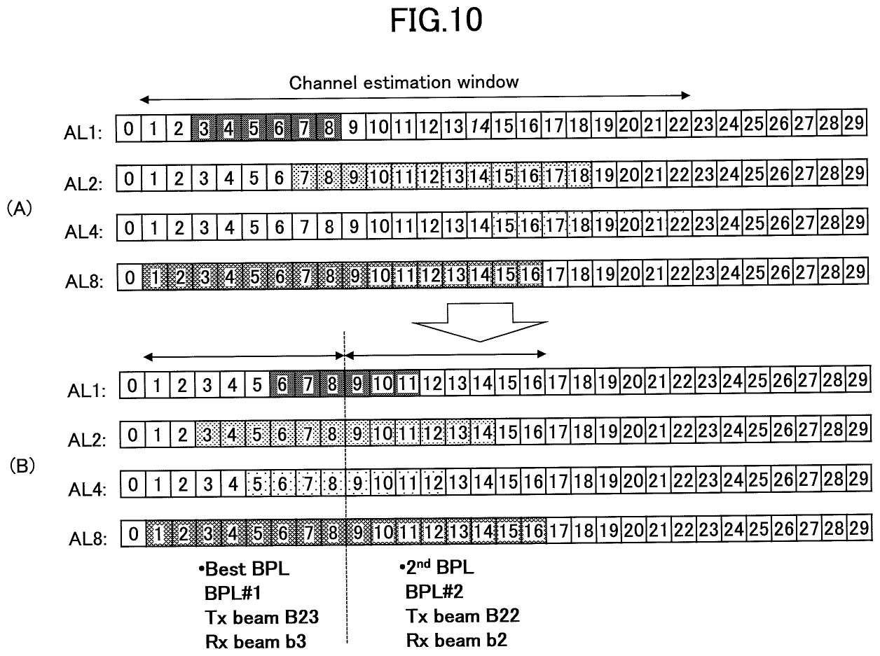

In FIG. 10A, a configuration of CCEs for transmission of PDCCH candidates in the LTE is illustrated. In the illustrated exemplary configuration, a channel estimation window composed of 22 CCEs is configured. Meanwhile, in the NR, there is discussion of the channel estimation window being made shorter for reduction in channel estimation load. To this end, in the NR, a channel estimation window composed of eight CCEs is configured as illustrated in FIG. 10B, for example, and PDCCH candidates are accommodated in the shorter channel estimation window. Accordingly, the US-SSs for respective user apparatuses 200 may be configured such that the PDCCH candidates for respective BPLs may be overlapped with each other.

Specifically, the PDCCH candidates are arranged to CCEs#6-#8 in AL=1, the PDCCH candidates are arranged to CCEs#4-#8 in AL=2, the PDCCH candidates are arranged to CCEs#5-#8 in AL=4, the PDCCH candidates are arranged to CCEs#1-#8 in AL=8, and BPL#1 is applied in CCEs#1-#8. Also, the PDCCH candidates are arranged to CCEs#9-#11 in AL=1, the PDCCH candidates are arranged to CCEs#9-#14 in AL=2, the PDCCH candidates are arranged to CCEs#9-#12 in AL=4, the PDCCH candidates are arranged to CCEs#9-#16 in AL=8, and BPI#2 is applied in CCEs#9-#16. In this manner, the PDCCH candidates allocated to CCEs#1-#8 associated with BPL#1 and the PDCCH candidates allocated to CCEs#9-#16 associated with BPL#2 are not limited to them, and they may be arranged to be made symmetric with respect to a boundary of radio resources. If a radio signal is transmitted to the user apparatus 200 in such a radio resource configuration, the transmission and reception unit 210 receives the radio signal in a CCE within the UE-SS for the user apparatus 200, and the signal processing unit 220 applies a reception beam corresponding to the received radio signal to retrieve various types of information including the PDCCH from the radio signal.

According to this embodiment, the shorter channel estimation window can be implemented through arrangement where the PDCCH candidates per the aggregation level may be overlapped with each other, and channel estimation load can be reduced.

Also, in one embodiment, the scheduling unit 110 may allocate the control information for transmission to the user apparatus 200 in multiple radio resources corresponding to different transmission beams within a search space specific to the user apparatus 200. In this case, the transmission and reception unit 210 may receive the radio signal in multiple radio resources allocated for the control information transmitted to the user apparatus 200 corresponding to different transmission beams within a search space specific to the user apparatus 200, and the signal processing unit 220 may decode the radio signal with a reception beam corresponding to the received radio resource and retrieve the control information transmitted to the user apparatus 200.

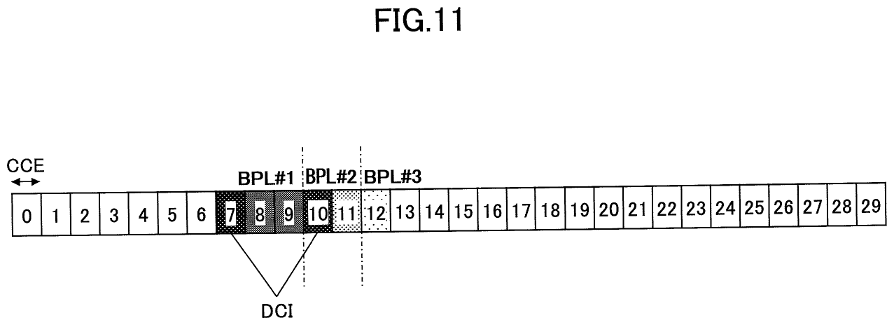

Specifically, as illustrated in FIG. 11, the scheduling unit 110 may allocate the control information (DCI) in CCEs for both BPL#1 and BPL#2. In other words, the control information is transmitted in a subset corresponding to multiple BPLs within the UE-SS. In this case, the transmission and reception unit 210 can receive the same DCI in both CCE#7 associated with BPL#1 and CCE#10 associated with BPL#2, and the signal processing unit 220 may receive the DCI in these two CCEs#7 and #10 in a combination manner or selectively receive one of them.

For example, the signal processing unit 120 ay indicate to the user apparatus 200 that DCI has been transmitted in multiple CCEs. This indication may be performed by upper layer signaling or broadcast signaling, for example.

Also, the signal processing unit 120 may indicate paired CCEs to the user apparatus 200. This indication may include CCE indices indicative of the paired CCEs, for example. Also, the indication may be performed by upper layer signaling or broadcast signaling, for example.

Also, in the selective reception, the signal processing unit 220 may blindly estimate all PDCCH candidates and selectively receive one of the detected DCI in accordance with predetermined selection criteria. For example, this selection criteria may be to select DCI having a high or low aggregation level, to select DCI having a high or low BPL priority, to select DCI having a high or low CCE index, or the like.

According to this embodiment, the control information is transmitted in multiple radio resources associated with different transmission beams, and the control information can be accordingly received more reliably.

Note that a segmentation method for segmenting radio resources within the UE-SS into subsets associated with respective BPLs may be indicated by upper layer signaling or broadcast signaling or may be defined in specifications. Also, the number of segmented subsets may be determined corresponding to the number of BPLs reported from the user apparatus 200. For example, if two BPLs are reported, the number of segmented subsets is set to 2. Alternatively, if three BPLs are reported, the number of segmented subsets may be set to 3. Also, association of respective subsets with BPLs may be indicated by upper layer signaling or broadcast signaling or may be defined in specifications.

Here, the block diagrams for use in the above description of embodiments show blocks for functional units. These functional blocks (components) are implemented in any combination of hardware and/or software items. Also, the implementations of the respective functional blocks are not particularly limited. In other words, the respective functional blocks may be implemented in a physically and/or logically coupled single device or in multiple devices where two or more physically and/or logically separated devices are connected directly and/or indirectly (for example, in wired and/or wireless manners).

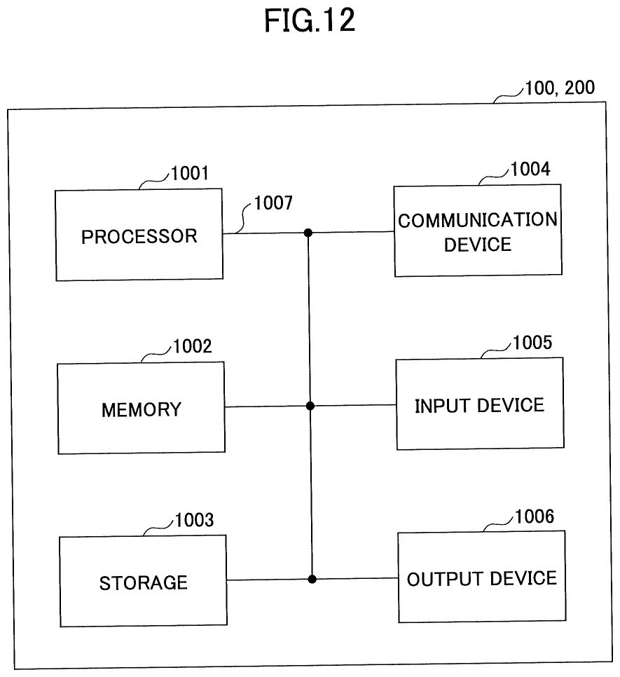

For example, the base station 100 and the user apparatus 200 according to one embodiment of the present invention may function as a computer processing the radio communication method according to the present invention. FIG. 12 is a block diagram for illustrating a hardware arrangement of the base station 100 and the user apparatus 200 according to one embodiment of the present invention. The base station 100 and the user apparatus 200 as stated above may each be physically arranged as a computer device including a processor 1001, a memory 1002, a storage 1003, a communication device 1004, an input device 1005, an output device 1006, a bus 1007 or the like.

Note that the language “apparatus” can be interchangeably read as a circuit, a device, a unit or the like. The hardware arrangement of the base station 100 and the user apparatus 200 may each be arranged to include one or more of the illustrated devices or without including a part of the devices.

Respective functions in the base station 100 and the user apparatus 200 are implemented by loading a predetermined software item (program) into hardware items such as the processor 1001 and the memory 1002 to cause the processor 1001 to execute operations, perform communication with the communication device 1004 and control read and/or write operations on data from/in the memory 1002 and the storage 1003.

The processor 1001 runs an operating system to control the whole computer, for example. The processor 1001 may be arranged with a central processing unit (CPU) including an interface with a peripheral device, a control device, a calculation device, a register and the like. For example, the above-stated components may be implemented in the processor 1001.

Also, the processor 1001 loads programs (program codes), software modules and data from the storage 1003 and/or the communication device 1004 into the memory 1002 and executes various operations in accordance with them. As the programs, programs for causing the computer to perform at least a part of operations as described in the above embodiments are used. For example, operations by the components in the base station 100 and the user apparatus 200 may be implemented with control programs stored in the memory 1002 and executed by the processor 1001, and other functional blocks may be similarly implemented. It has been described that the above-stated various operations are performed by the single processor 1001, but they may be performed with two or more processors 1001 simultaneously or sequentially. The processor 1001 may be implemented with one or more chips. Note that the programs may be transmitted from a network via an electric communication line.

The memory 1002 is a computer-readable storage medium and may be arranged with at least one of a ROM (Read Only Memory) , an EPROM (Erasable Programmable ROM), an EEPROM (Electrically Erasable Programmable ROM), a RAM (Random Access Memory) or the like, for example. The memory 1002 may be referred to as a register, a cache, a main memory (main storage device) or the like. The memory 1002 can store programs (program codes), software modules or the like that can be executed to implement the radio communication method according to one embodiment of the present invention.

The storage 1003 is a computer-readable storage medium and may be arranged with at least one of an optical disk such as a CD-ROM (Compact Disc ROM), a hard disk drive, a flexible disk, a magnetic optical disk (for example, a compact disk, a digital versatile disk, a Blu-ray (registered trademark) disk), a smart card, a flash memory (for example, a card, a stick, a key drive) , a floppy (registered trademark), a magnetic strip or the like. The storage 1003 may be referred to as an auxiliary storage device. The above-stated storage medium may be a database or a server including the memory 1002 and/or the storage 1003 or any other appropriate medium.

The communication device 1004 is a hardware item (transceiver device) for communication over computers via a wired and/or wireless network and may be also referred to as a network device, a network controller, a network card, a communication module or the like. For example, the above-stated components may be implemented in the communication device 1004.

The input device 1005 is an input device for receiving external inputs (for example, a keyboard, a mouse, a microphone, a switch, a button, a sensor or the like). The output device 1006 is an output device for providing external outputs (for example, a display, a speaker, a LED ramp or the like). Note that the input device 1005 and the output device 1006 may be integrally arranged (for example, a touch panel).

Also, the respective devices such as the processor 1001 and the memory 1002 are connected with each other via the bus 1007 for communicating information. The bus 1007 may be arranged with a single bus or different buses for different devices.

Also, the base station 100 and the user apparatus 200 may be arranged to include a hardware item such as a macro processor, a digital signal processor (DSP), an ASIC (Application Specific Integrated Circuit), a PLD (Programmable Logic Device), a FPGA (Field Programmable Gate Array) or the like, and a part or all of the functional blocks may be implemented in the hardware item. For example, the processor 1001 may be implemented with at least one of these hardware items.

Transmission of information is not limited to the embodiments/implementations as described in the present specification and may be made in any other manner. For example, information may be transmitted in physical layer signaling (for example, DCI (Downlink Control Information) and UCI (Uplink Control Information)), upper layer signaling (for example, RRC (radio Resource Control) signaling, MAC (medium Access Control) signaling, broadcast information (MIB (master Information Block) and SIB (System Information Block)) or any other signal or combinations thereof. Also, the RRC signaling may be referred to as an RRC message and may be an RRC Connection Setup message, an RRC Connection Reconfiguration message or the like.

The respective embodiments/implementations as described in the present specification may be applied to systems using LTE (Long Term Evolution), LTE-A (LTE-Advanced), SUPER 3G, IMT-Advanced, 4G, 5G, FRA (Future Radio Access), W-CDMA (registered trademark), GSM (registered trademark) , CDMA 2000, UMB (Ultra Mobile Broadband), IEEE 802.11 (Wi-Fi), IEEE 802.16 (WiMAX), IEEE 802.20, UWB (Ultra-WideBand), Bluetooth (registered trademark) or any other appropriate system or next-generation systems enhanced based on them.

Procedures, sequences, flowcharts or the like of the respective embodiments/implementations as described in the present specification may be permutable, as long as there is not inconsistency. For example, for methods as described in the present specification, various steps are presented in an exemplary order, and the present invention is not limited to the presented certain order.

Certain operations performed by the base station 100 as described in the present specification may be performed by its upper node in some cases. In a network including one or more network nodes having base stations, various operations performed to communicate with terminals may be apparently performed by the base stations and/or network nodes other than the base stations (for example, a MME or an S-SW can be assumed, but the network nodes are not limited to them). Although it has been described that the single network node other than the base stations is used in the above example, combinations of multiple other network nodes (for example, an MME and an S-GW) may be used.

Information and others may be output from an upper layer (or a lower layer) to a lower layer (or an upper layer). They may be input and output via multiple network nodes.

Incoming and outgoing information and others may be stored in a certain location (for example, a memory) and/or managed in a management table. The incoming and outgoing information and others may be overwritten, updated or added. The outgoing information and others may be deleted. The incoming information and others may be transmitted to other device.

Determination may be made with a one-bit value (0 or 1), a Boolean value (true or false) or numerical comparison (for example, comparison with a predetermined value).

The embodiments/implementations as described in the present specification may be used singularly or in combinations or switched in connection with execution. Also, indication of predetermined information (for example, indication “it is X”) is not limited to explicit manners and may be performed implicitly (for example, the predetermined information is not indicated).

Although the present invention has been described in detail, it is apparent to those skilled in the art that the present invention is not limited to the embodiments as described in the present specification. The present invention can be implemented as modifications and variations without departing from the sprit and scope of the present invention as defined in claims. Thus, the description in the present specification is intended for exemplary description and does not mean any restriction to the present invention.

Software should be broadly interpreted to mean an instruction, an instruction set, a code, a code segment, a program code, a program, a subprogram, a software module, an application, a software application, a software package, a routine, a subroutine, an object, an executable file, an execution thread, a procedure, a function or the like regardless of the software being referred to as software, a firmware, a middleware, a microcode, a hardware descriptive language or other names.

Also, the software, the instruction or the like may be transmitted and received via a transmission medium. For example, if the software is transmitted from a website, a server or other remote sources by using wired techniques such as a coaxial cable, an optical fiber cable, a twist pair and a digital subscriber line (DSL) and/or wireless techniques such as infrared, radio frequency and microwave, these wired techniques and/or wireless techniques are included within definition of a transmission medium.

Information, signals or the like as described in the present specification may be represented with use of any of various different techniques. For example, data, an instruction, a command, information, a signal, a bit, a symbol, a chip and so on referred to throughout the above description may be represented with a voltage, a current, an electromagnetic wave, a magnetic field, a magnetic particle, an optical field, a photon or any combination thereof.

Note that terminologies described in the present specification and/or terminologies required to understand the present specification may be replaced with terminologies having the same or similar meanings. For example, a channel and/or a symbol may be a signal. Also, the signal may be a message. Also, a component carrier (CC) may be referred to as a carrier frequency, a cell or the like.

The terminologies “system” and “network” for use in the present specification are interchangeably used.

Also, information, a parameter and so on as described in the present specification may be represented with an absolute value, a relative value from a predetermined value or other corresponding information. For example, a radio resource may be specified with an index.

Names as used for the above-stated parameters are not restrictive from any standpoint. Furthermore, there are some cases where formulae and so on using these parameters may be different from ones as explicitly disclosed in the present specification. Various channels (for example, a PUCCH, a PDCCH or the like) and information elements (for example, a TPC or the like) can be identified with any preferred names, and the various names allocated to these various channels and information elements are not restrictive from any standpoint.

A base station can accommodate one or more (for example, three) cells (also referred to as sectors). If the base station accommodates multiple cells, the whole coverage area of the base station can be segmented into multiple smaller areas, and the respective smaller areas can provide communication services with a base station subsystem (for example, indoor small base station RRH: Remote Radio Head). The terminology “cell” or “sector” indicates a part or whole of the coverage area of the base station providing communication services in the coverage and/or the base station subsystem. Furthermore, the terminologies “base station”, “eNB”, “cell” and “sector” can be interchangeably used in the present specification. The base station may be referred to as terminologies such as a fixed station, a NodeB, an eNodeB (eNB), an access point, a femtocell and a small cell.

A mobile station may be referred to by those skilled in the art as a subscriber station, a mobile unit, a subscriber unit, a wireless unit, a remote unit, a mobile device, a wireless device, a wireless communication device, a remote device, a mobile subscriber station, an access terminal, a mobile terminal, a wireless terminal, a remote terminal, a handset, a user agent, a mobile client, a client or any other appropriate terminologies.

There are some cases where terminologies “determining” as used in the present specification may include various operations. The “determining” may include calculating, computing, processing, deriving, investigating, looking up (for example, looking up a table, a database or other data structures) and ascertaining, for example. Also, the “determining” may include receiving (for example, receiving information), transmitting (for example, transmitting information), inputting, outputting and accessing (for example, accessing data in a memory) . Also, the “determining” may include resolving, selecting, choosing, establishing, comparing or the like. In other words, the “determining” may include any operation.

The terminologies “connected”, “coupled” or all variations thereof mean direct or indirect connection or coupling between two or more elements and can include existence of one or more intermediate elements between two mutually “connected” or “coupled” elements. The coupling or connection between elements may be physical, logical or in combinations thereof. If they are used in the present specification, it can be considered that two elements are mutually “connected” or “coupled” with use of one or more electric wires, cables and/or print electric connections and as several non-limiting and non-comprehensive examples, with use of electromagnetic energy such as electromagnetic energy having a wavelength of a radio frequency domain, a microwave domain and an optical (both visible and invisible) domain.

A reference signal can be omitted as a RS (Reference Signal) and may be referred to as a pilot depending on applied standards.

The recitation “based on” as used in the present specification does not mean “only based on”, unless specifically stated otherwise. In other words, the recitation “based on” means both “only based on” and “at least based on”.

Any reference to elements with use of terminologies such as “first”, “second” and so on as used in the present specification does not limit the amount or order of these elements in general. These terminologies can be used in the present specification as convenient manners for distinguishing between two or more elements. Accordingly, the reference to the first and second elements does not mean that only the two elements are used there or the first element has to precede the second element in any fashion.

The terminology “means” in an arrangement of each apparatus as stated above may be replaced with “unit”, “circuit”, “device” or the like.

As long as the terminologies “include”, “including” and variations thereof are used in the present specification or claims, these terminologies are intended to be inclusive similar to the terminology “comprising”. Furthermore, the terminology “or” as used in the present specification or claims is intended not to be an exclusive OR.

A radio frame may be arranged with one or more frames in a time domain. In the time domain, one or more frames each may be referred to as a subframe. The subframe may be further arranged with one or more slots in the time domain. The slot may be further arranged with one or more symbols (OFDM symbols, SC-FDMA symbols and so on) in the time domain. Any of the radio frame, the subframe, the slot and the symbol represents a time unit for transmitting signals. The radio frame, the subframe, the slot and the symbol may be referred to in other corresponding manners. For example, in LTE systems, a base station performs scheduling to allocate radio resources (frequency bandwidths, transmission power and so on available in the mobile station) to mobile stations. The minimum time unit for scheduling may be referred to as a TTI (Transmission Time Interval). For example, one subframe, multiple contiguous subframes or one slot may be referred to as the TTI. A resource block (RB) may be a resource assignment unit in the time domain and the frequency domain and may include one or more contiguous subcarriers in the frequency domain. Also, in the time domain, the resource block may include one or more symbols and have one slot, one subframe or one TTI in length. The single TTI and subframe each may be arranged with one or more resource blocks. The above-stated arrangement of radio frame is merely exemplary, and the number of subframes in the radio frame, the number of slots in the subframe, the number of symbols and resource blocks in the slot and the number of subcarriers in the resource block can be changed in any manner.

Although the embodiments of the present invention have been described in detail, the present invention is not limited to the above-stated specific embodiments, and various modifications and variations can be made within the spirit of the present invention as recited in claims.

This patent application is based on and claims priority to Japanese Patent Application No. 2017-023566 filed on Feb. 10, 2017, the entire contents of which are hereby incorporated by reference.

### LIST OF REFERENCE SYMBOLS

10 radio communication system
100 base station
110 scheduling unit
120 signal processing unit
200 user apparatus
210 transmission and reception unit
220 signal processing unit

1. A base station, comprising:
a scheduling unit configured to allocate a radio resource to a user apparatus; and
a signal processing unit configured to process a radio signal for transmission to and reception from the user apparatus,
wherein the scheduling unit allocates control information for transmission to the user apparatus to a radio resource within a search space specific to the user apparatus, and the signal processing unit transmits the control information to the user apparatus with a transmission beam corresponding to the allocated radio resource among multiple types of transmission beams.

2. The base station as claimed in claim 1, wherein the scheduling unit configures a number of radio resources allowed to transmit the control information for each transmission beam in the multiple types of transmission beams.

3. The base station as claimed in claim 1, wherein the scheduling unit selects a transmission beam to be used from the multiple types of transmission beams corresponding to an aggregation level.

4. The base station as claimed in claim 1, wherein the scheduling unit causes radio resources allowed to transmit the control information with each transmission beam in the multiple types of transmission beams to be overlapped with respect to different aggregation levels.

5. The base station as claimed in claim 1, wherein the scheduling unit allocates the control information for transmission to the user apparatus to multiple radio resources corresponding to different transmission beams within a search space specific to the user apparatus.

6. A user apparatus, comprising:
a transmission and reception unit configured to transmit and receive a radio signal to and from a base station; and
a signal processing unit configured to process the radio signal,
wherein the transmission and reception unit receives a radio signal in a radio resource within a search space specific to the user apparatus, and the signal processing unit decodes the radio signal with a reception beam corresponding to the received radio resource among multiple types of reception beams and extracts control information transmitted to the user apparatus.

7. The user apparatus as claimed in claim 6, wherein the transmission and reception unit receives the radio signal in a number of radio resources configured for each reception beam in the multiple types of reception beams, and the signal processing unit decodes the radio signal with a reception beam corresponding to the configured number of radio resources and extracts the control information transmitted to the user apparatus.

8. The user apparatus as claimed in claim 6, wherein the transmission and reception unit receives the radio signal in a radio resource configured for each reception beam selected from the multiple types of reception beams corresponding to an aggregation level, and the signal processing unit decodes the radio signal with a reception beam corresponding to the received radio resource and extracts the control information transmitted to the user apparatus.

9. The user apparatus as claimed in claim 6, wherein the transmission and reception unit is allowed to receive the control information with each reception beam in the multiple types of reception beams and receives the radio signal in a radio resource overlapping with respect to different aggregation levels, and the signal processing unit decodes the radio signal with a reception beam corresponding to the received radio resource and extracts the control information transmitted to the user apparatus.

10. The user apparatus as claimed in claim 6, wherein the transmission and reception unit receives the radio signal in multiple radio resources to which the control information transmitted to the user apparatus is allocated, the radio resources corresponding to different transmission beams within a search space specific to the user apparatus, and the signal processing unit decodes the radio signal with a reception beam corresponding to the received radio resource and extracts the control information transmitted to the user apparatus.

11. The base station as claimed in claim 2, wherein the scheduling unit selects a transmission beam to be used from the multiple types of transmission beams corresponding to an aggregation level.

12. The base station as claimed in claim 2, wherein the scheduling unit causes radio resources allowed to transmit the control information with each transmission beam in the multiple types of transmission beams to be overlapped with respect to different aggregation levels.

13. The base station as claimed in claim 3, wherein the scheduling unit causes radio resources allowed to transmit the control information with each transmission beam in the multiple types of transmission beams to be overlapped with respect to different aggregation levels.

14. The base station as claimed in claim 2, wherein the scheduling unit allocates the control information for transmission to the user apparatus to multiple radio resources corresponding to different transmission beams within a search space specific to the user apparatus.

15. The base station as claimed in claim 3, wherein the scheduling unit allocates the control information for transmission to the user apparatus to multiple radio resources corresponding to different transmission beams within a search space specific to the user apparatus.

16. The base station as claimed in claim 4, wherein the scheduling unit allocates the control information for transmission to the user apparatus to multiple radio resources corresponding to different transmission beams within a search space specific to the user apparatus.

17. The user apparatus as claimed in claim 7, wherein the transmission and reception unit receives the radio signal in a radio resource configured for each reception beam selected from the multiple types of reception beams corresponding to an aggregation level, and the signal processing unit decodes the radio signal with a reception beam corresponding to the received radio resource and extracts the control information transmitted to the user apparatus.

18. The user apparatus as claimed in claim 7, wherein the transmission and reception unit is allowed to receive the control information with each reception beam in the multiple types of reception beams and receives the radio signal in a radio resource overlapping with respect to different aggregation levels, and the signal processing unit decodes the radio signal with a reception beam corresponding to the received radio resource and extracts the control information transmitted to the user apparatus.

19. The user apparatus as claimed in claim 8, wherein the transmission and reception unit is allowed to receive the control information with each reception beam in the multiple types of reception beams and receives the radio signal in a radio resource overlapping with respect to different aggregation levels, and the signal processing unit decodes the radio signal with a reception beam corresponding to the received radio resource and extracts the control information transmitted to the user apparatus.

20. The user apparatus as claimed in claim 7, wherein the transmission and reception unit receives the radio signal in multiple radio resources to which the control information transmitted to the user apparatus is allocated, the radio resources corresponding to different transmission beams within a search space specific to the user apparatus, and the signal processing unit decodes the radio signal with a reception beam corresponding to the received radio resource and extracts the control information transmitted to the user apparatus.
